(19) United States
(12) Patent Application Publication
(10) Pub. No.: US 2026/0104668 A1
(43) Pub. Date: Apr. 16, 2026

(54) SHEET FEED DEVICE AND IMAGE FORMING APPARATUS INCLUDING THE SAME

(71) Applicant: KYOCERA Document Solutions Inc., Osaka (JP)

(72) Inventor: Hideaki DOYO, Osaka (JP)

(73) Assignee: KYOCERA Document Solutions Inc., Osaka (JP)

(21) Appl. No.: 19/348,229

(22) Filed: Oct. 2, 2025

(30) Foreign Application Priority Data
Oct. 11, 2024 (JP) 2024-178807

(51) Int. Cl. G03G 15/00

(52) U.S. Cl. CPC G03G 15/6558

(57) ABSTRACT

A retard roller includes a roller main body, a shaft, a torque limiter, a holding member, and a restriction member. The torque limiter switches the roller main body between rotation and stopping. The holding member is disposed on one side of the roller main body in an axial direction thereof and supports the shaft. The restriction member is disposed on the other side of the roller main body in the axial direction thereof, includes a locking portion locked to the shaft, and restricts movement of the roller main body in the axial direction thereof. The roller main body is swingably supported via a first support portion provided in the holding member and a second support portion provided in the restriction member, and is pressed against the feed roller.

### INCORPORATION BY REFERENCE

This application is based on and claims the benefit of priority from Japanese Patent Application No. 2024-178807 filed on October 11, 2024, the contents of which are hereby incorporated by reference.

### BACKGROUND

The present disclosure relates to a sheet feed device and an image forming apparatus including the same.

Conventional sheet feed devices include a feed roller and a retard roller. The feed roller rotates when a driving force is transmitted thereto, thereby conveying a sheet. The retard roller is pressed against the feed roller to form a nip portion, and conveys a sheet while separating the sheet from another sheet. The retard roller includes a roller main body, a shaft, a torque limiter, a holding member, and a restriction member. The roller main body rotates about a rotation axis. The shaft is attached to the roller main body and extends along the rotation axis. The torque limiter switches the roller main body between rotation and stopping. The holding member is disposed on one side of the roller main body in an axial direction thereof, and supports the shaft. The roller main body is swingably supported via a support portion provided in the holding member, and is pressed against the feed roller.

However, in such conventional sheet feed devices, the pressing force exerted by the roller main body on the feed roller tends to be uneven in the axial direction. As a result, through continued use, the roller main body may wear unevenly toward one side in the axial direction, causing sheet conveyance failure. Moreover, the service life of the roller main body may be shortened, resulting in increased maintenance costs.

The present disclosure aims to provide a sheet feed device capable of reducing sheet feed failure while minimizing maintenance costs, and an image forming apparatus including the same.

### SUMMARY

To solve the problems described above, according to a first aspect of the present disclosure, a sheet feed device includes a feed roller and a retard roller. The feed roller rotates when a driving force is transmitted thereto, thereby conveying a sheet. The retard roller is pressed against the feed roller to form a nip portion, and conveys the sheet while separating the sheet from another sheet. The retard roller includes a roller main body, a shaft, a torque limiter, a holding member, and a restriction member. The roller main body rotates about a rotation axis. The shaft is attached to the roller main body so as to extend along the rotation axis. The torque limiter switches the roller main body between rotation and stopping. The holding member is disposed on one side of the roller main body in an axial direction thereof and supports the shaft. The restriction member is disposed on the other side of the roller main body in the axial direction thereof, includes a locking portion locked to the shaft, and restricts movement of the roller main body in the axial direction thereof. The roller main body is swingably supported via a first support portion provided in the holding member and a second support portion provided in the restriction member, and is pressed against the feed roller.

This and other objects of the present disclosure, and the specific benefits obtained according to the present disclosure, will become apparent from the description of embodiments which follows.

### BRIEF DESCRIPTION OF THE DRAWINGS

FIG. 1 is a schematic sectional view showing an overall configuration of an image forming apparatus 100 according to one embodiment of the present disclosure.

FIG. 2 is a perspective view of a sheet feed device 60 according to one embodiment of the present disclosure.

FIG. 3 is a perspective view showing, in an enlarged manner, part of the sheet feed device 60 according to one embodiment of the present disclosure.

FIG. 4 is a perspective view of a retard roller 64 of the sheet feed device 60 according to one embodiment of the present disclosure.

FIG. 5 is a sectional view of a torque limiter 644 of the retard roller 64 incorporated in the sheet feed device 60 according to one embodiment of the present disclosure.

### DETAILED DESCRIPTION

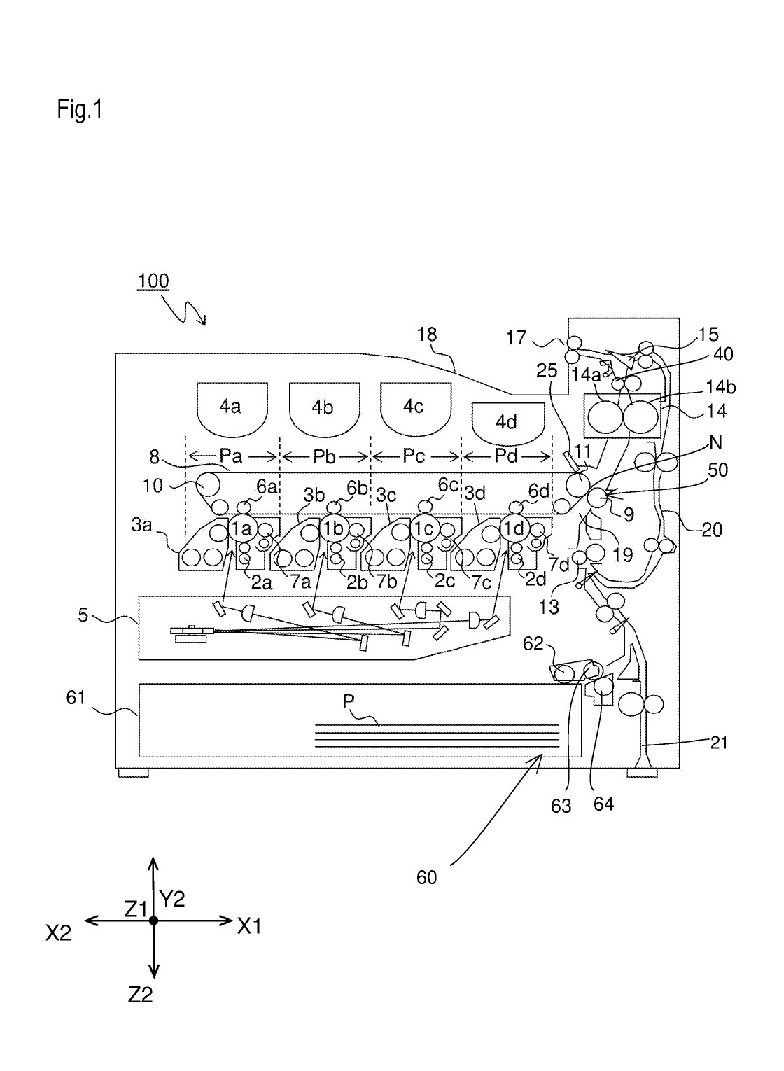

Hereinafter, an embodiment of the present disclosure will be described with reference to the accompanying drawings. FIG. 1 is a sectional view showing an inner structure of an image forming apparatus 100 according to one embodiment of the present disclosure. For the convenience of description, a vertical direction in a state where the image forming apparatus 100 is usably installed (the state shown in FIG. 1) is defined as an up-down direction (Z1-Z2). Regarding a face of the image forming apparatus 100, the face being located on the side forward of the plane on which FIG. 1 is depicted, as the front face (i.e., the front) of the image forming apparatus 100, a front-rear direction (Y1-Y2) is defined. With reference to the front face of the image forming apparatus 100 in the installed state, a left-right direction (X1-X2) is defined. In the present embodiment, the left-right direction (X1-X2) is orthogonal to both the up-down direction (Z1-Z2) and the front-rear direction (Y1-Y2). Further, the left-right direction (X1-X2) is a sheet conveyance direction in which the retard roller 64 conveys a sheet, and the front-rear direction (Y1-Y2) is the axial direction of the retard roller 64. It should be noted that the definition of the up-down direction does not in any way limit the orientation or positional relationship of the image forming apparatus 100 during use.

### Configuration of Image Forming Apparatus

The image forming apparatus 100 includes image forming portions Pa to Pd, a sheet feed device 60, a transfer portion 50, a fixing portion 14, a discharge portion 17, a conveyance roller pair 40, a sheet conveyance path 19, and a branching conveyance path 20. The image forming apparatus 100 prints an image on a sheet P fed from the sheet feed device 60.

Specifically, in the main body of the image forming apparatus 100 (here, a color printer), the four image forming portions Pa, Pb, Pc, and Pd are arranged in order from the upstream side in the conveyance direction (the left side in FIG. 1).

More specifically, the image forming portions Pa to Pd are provided respectively corresponding to images of four different colors (i.e., yellow, cyan, magenta, and black). he image forming portions Pa to Pd sequentially form images of yellow, cyan, magenta, and black, respectively, through processes of charging, exposure, development, and transfer.

The image forming portions Pa to Pd respectively form visible images (toner images) of their corresponding colors on photosensitive drums (image carriers) 1a to 1d. Further, an intermediate transfer belt (an intermediate transfer body) 8 is provide adjacent to the image forming portions Pa to Pd. The toner images formed on the photosensitive drums 1a to 1d are primarily transferred sequentially onto the intermediate transfer belt 8, which moves in contact with the photosensitive drums 1a to 1d, such that the toner images are superimposed one on top of another.

The transfer portion 50 transfers the toner images formed in the image forming portions Pa to Pd onto a sheet P (a recording medium). The transfer portion 50 includes a drive roller 11 and a secondary transfer roller 9. Specifically, the toner images having been primarily transferred onto the intermediate transfer belt 8 are secondarily transferred by the secondary transfer roller 9 onto the sheet P used as an example of the recording medium. The sheet P having the toner images secondarily transferred thereon is subjected to the fixing of the toner images by the fixing portion 14, and is then discharged from the main body of the image forming apparatus 100.

The sheet feed device 60 feeds a sheet P to the image forming portions Pa to Pd. The sheet feed device 60 includes a sheet cassette 61, a pickup roller 62, a feed roller 63, and a retard roller 64. The pickup roller 62 is disposed on an upper side Z1 of the sheet cassette 61. The sheet cassette 61 is disposed at a lower part in the main body of the image forming apparatus 100, and stores sheets P onto which toner images are to be secondarily transferred.

The pickup roller 62 is pressed against the upper surface of a sheet P with predetermined pressure. The pickup roller 62 is caused to rotate to thereby start the feeding of the sheet P. That is, the pickup roller 62 makes contact with a sheet P stored in the sheet cassette 61, and sends out the sheet P into the sheet conveyance path 19.

The feed roller 63 rotates when a driving force is transmitted thereto, thereby conveying the sheet P having been sent out by the pickup roller 62. Specifically, between the feed roller 63 and the pickup roller 62, there is disposed a driving force transmission gear (unillustrated) which transmits the rotation of the feed roller 63 to the pickup roller 62.

The retard roller 64 is pressed against the feed roller 63 to form a nip portion, conveying sheets P while separating them one from another. Specifically, the retard roller 64, which incorporates a later-described torque limiter 644, is pressed against the feed roller 63 to be driven to rotate.

With this arrangement, in a case where a plurality of sheets P are simultaneously fed by the pickup roller 62, the feed roller 63 and the retard roller 64 separate the sheets P one from another, such that solely a topmost one of the sheets P is separated from the others and sent out toward the sheet conveyance path 19. After passing through the sheet conveyance path 19, the sheet P reaches a registration roller pair 13 and is then conveyed to a nip portion between the secondary transfer roller 9 and the drive roller 11 of the intermediate transfer belt 8 in coordination with the timing of image formation. The retard roller 64 will be described in detail later.

Used as the intermediate transfer belt 8 is a dielectric resin sheet, chiefly in the form of a belt with no seam (a seamless belt). Further, at a position downstream of the secondary transfer roller 9, a belt cleaner 25, which is blade-shaped, is disposed for removing toner and the like remaining on the surface of the intermediate transfer belt 8.

Around or below the photosensitive drums 1a to 1d, which are rotatably arranged, there are provided charging devices 2a, 2b, 2c, and 2d, an exposure device 5, developing devices 3a, 3b, 3c, and 3d, and cleaning devices 7a, 7b, 7c, and 7d. The charging devices 2a, 2b, 2c, and 2d charge the photosensitive drums 1a to 1d, respectively. The exposure device 5 exposes the photosensitive drums 1a to 1d to light based on image information. The developing devices 3a, 3b, 3c, and 3d form toner images of the photosensitive drums 1a to 1d, respectively. The cleaning devices 7a, 7b, 7c, and 7d remove developer (toner) and the like remaining on the photosensitive drums 1a to 1d, respectively.

When image data is fed in from a host device such as a personal computer, first, the charging devices 2a to 2d uniformly charge the surfaces of the photosensitive drums 1a to 1d, respectively. Subsequently, the exposure device 5 irradiates the photosensitive drums 1a to 1d with light according to the image data to form on them electrostatic latent images based on the image data. The developing devices 3a to 3d are loaded with a predetermined amount of two-component developers including yellow, cyan, magenta, and black toners, respectively. When toner ratios in the two-component developers respectively loaded in the developing devices 3a to 3d fall below a reference value, the toners are supplied from toner containers 4a to 4d to the developing devices 3a to 3d, respectively.

The toners in the developers are supplied by the developing devices 3a to 3d, and electrostatically adhere, onto the photosensitive drums 1a to 1d, respectively. In this manner, toner images are formed corresponding to the electrostatic latent images having been formed through the exposure by the exposure device 5.

Then, primary transfer rollers 6a to 6d impart an electric field at a predetermined transfer voltage between the primary transfer rollers 6a to 6d and the photosensitive drums 1a to 1d, respectively, and thereby, the yellow, cyan, magenta, and black toner images respectively on the photosensitive drums 1a to 1d are primarily transferred onto the intermediate transfer belt 8. These images are formed with a predetermined positional relationship. After that, in preparation for the subsequently performed formation of new electrostatic latent images, the toner and the like remaining on the surfaces of the photosensitive drums 1a to 1d after the primary transfer are removed by the cleaning devices 7a to 7d, respectively.

The intermediate transfer belt 8 is stretched around a driven roller 10 on an upstream side thereof and the drive roller 11 on a downstream side thereof. When the intermediate transfer belt 8 starts to rotate counterclockwise in accordance with the rotation of the drive roller 11 caused by a belt drive motor (unillustrated), a sheet P is conveyed from the registration roller pair 13, with predetermined timing, to a secondary transfer nip portion N formed between the drive roller 11 and the secondary transfer roller 9 provided adjacent to the drive roller 11. Then, the toner images on the intermediate transfer belt 8 are secondarily transferred onto the sheet P passing through the secondary transfer nip portion N.

The sheet P having the toner images secondarily transferred thereto is conveyed to the fixing portion 14. The fixing portion 14 includes a fixing belt 14a and a pressure roller 14b. The fixing belt 14a is heated by a heating device (unillustrated), such as a heater, an induction heating unit, and the like. The pressure roller 14b is pressed against the fixing belt 14a to form a fixing nip, and imparts a rotational driving force to the fixing belt 14a.

The sheet P having been conveyed to the fixing portion 14 is heated and pressed by the fixing belt 14a and the pressure roller 14b, and thereby the toner images are fixed to the surface of the sheet P, forming a predetermined full-color image.

The sheet P having the full-color image formed thereon passes through the conveyance roller pair 40 to be then guided by a conveyance guide member 15, which is disposed at the branching portion of the sheet conveyance path 19, into one of conveyance directions, and is then discharged as it is (or after being diverted to the branching conveyance path 20 to have images formed on both sides) onto a discharge tray 18 by a discharge roller pair (the discharge portion) 17.

The conveyance roller pair 40 sends the sheet P from the fixing portion 14 to the discharge roller pair (the discharge portion) 17.

The sheet conveyance path 19 connects the sheet feed device 60, the transfer portion 50, the fixing portion 14, and the discharge portion 17. The branching conveyance path 20 branches from the sheet conveyance path 19 on a downstream side of the conveyance roller pair 40, and rejoins the sheet conveyance path 19 on a downstream side of the registration roller pair 13. The branching conveyance path 20 extends in the up-down direction (Z1-Z2) along a side face 102 of the image forming apparatus 100, curving substantially in a C-shape.

### <Configuration of Retard Roller>

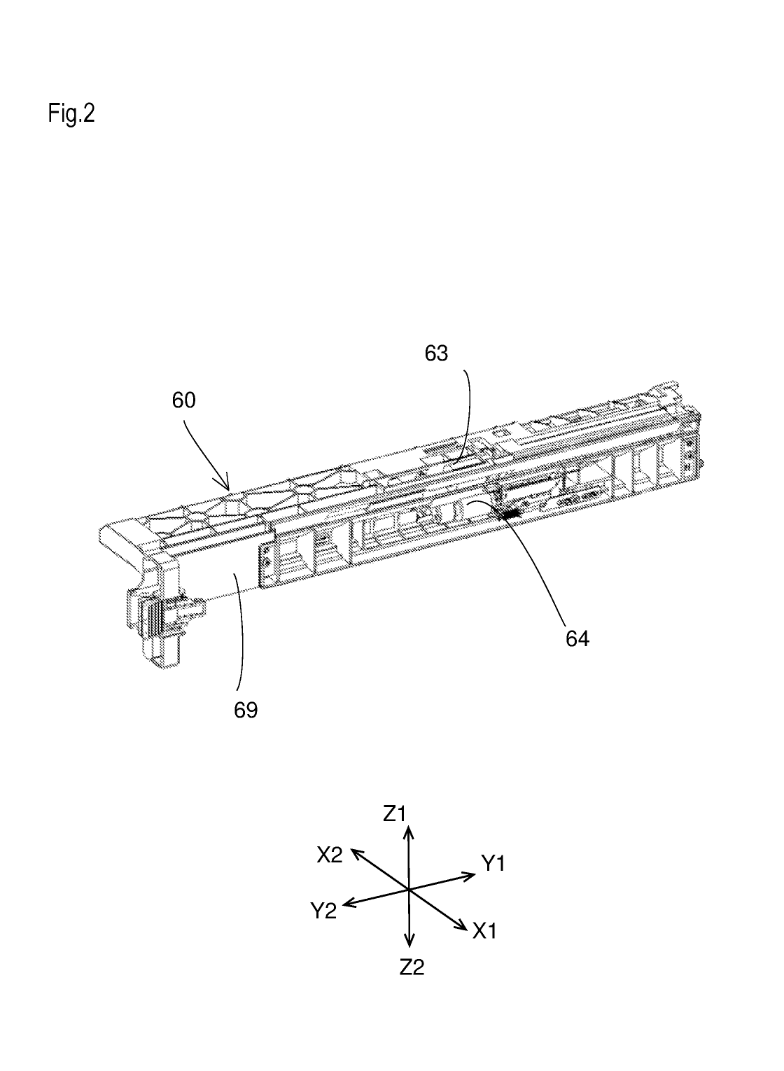

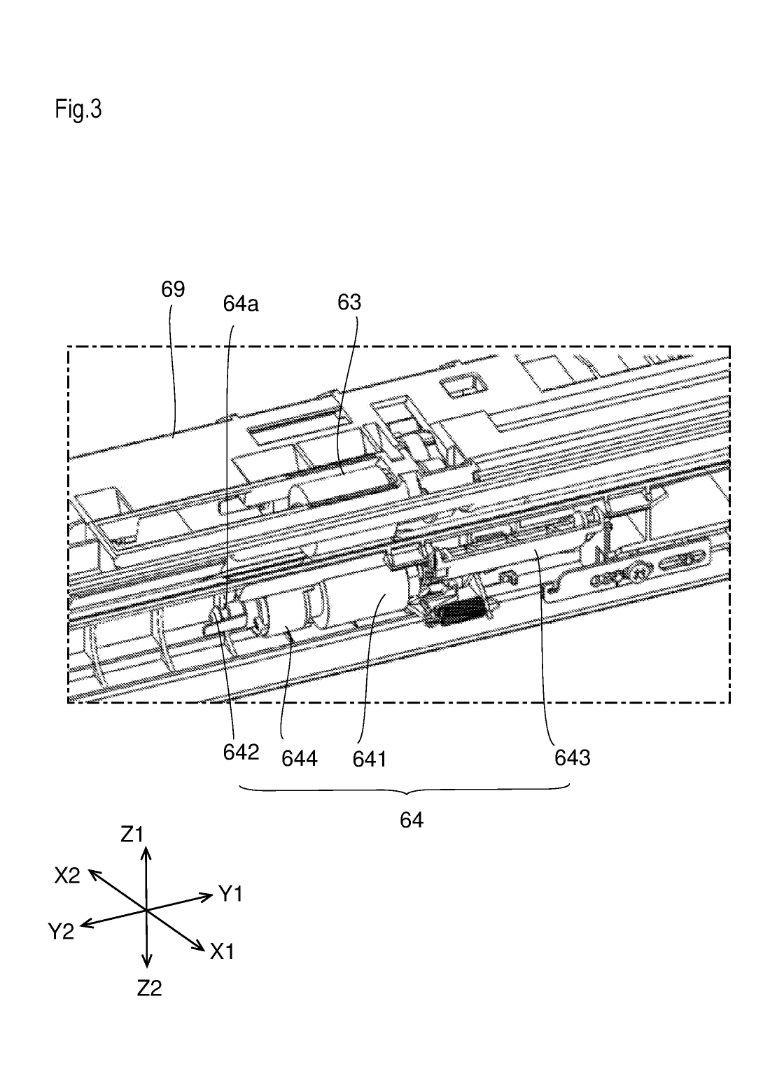

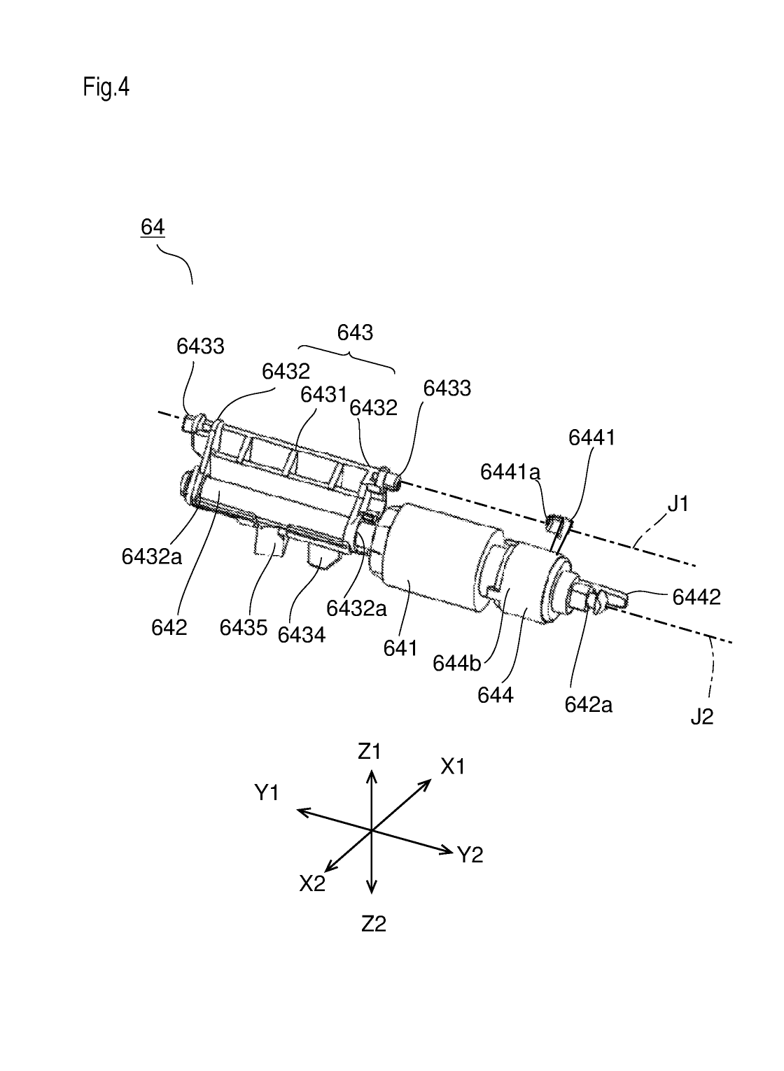

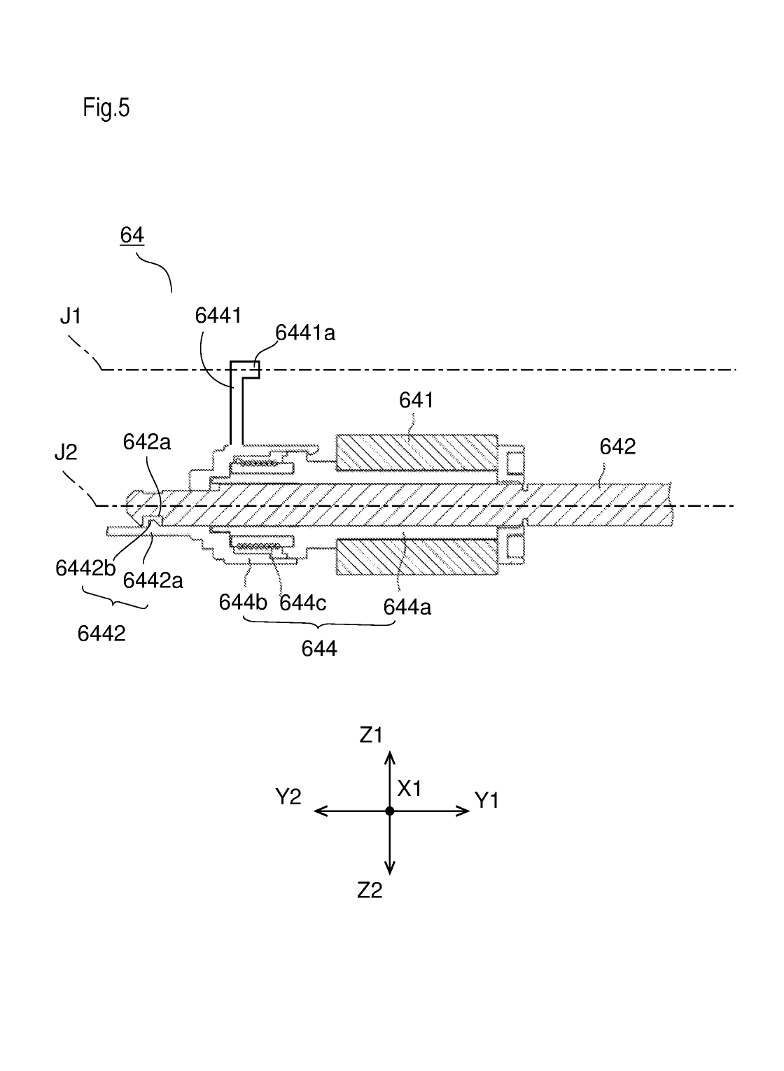

FIG. 2 is a perspective view showing part of the sheet feed device 60, and FIG. 3 is a partial sectional view showing part of the sheet feed device 60 in an enlarged manner. FIG. 4 is a perspective view of the retard roller 64, and FIG. 5 is a sectional view of the torque limiter 644. The sheet feed device 60 further includes a housing 69, which holds therein the feed roller 63 and the retard roller 64.

The retard roller 64 includes a roller main body 641, a shaft 642, a holding member 643, and the torque limiter 644.

The roller main body 641 rotates about a rotation axis J2. The roller main body 641 has at least its circumferential surface made of a material with a high friction coefficient, such as silicone rubber, urethane rubber, EPDM, or the like. The circumferential surface of the roller main body 641 wears out through continued use. When worn out, it becomes difficult for the roller main body 641 to be driven to rotate following the feed roller 63 in a satisfactory manner. Thus, the roller main body 641, whose performance has deteriorated, needs to be replaced.

The shaft 642 is attached to the roller main body 641, and extends along the rotation axis J2. The shaft 642 is a cylindrical metal body, for example. In the shaft 642, a groove portion 642a is formed at its end part on the other side Y2 in the axial direction by depressing its circumferential surface so as to extend in the circumferential direction.

The holding member 643 is disposed on the one side Y1 of the roller main body 641 in the axial direction, and supports the shaft 642. Specifically, the holding member 43 is a resin molded product, and includes a holding main body 6431, which extends in the axial direction (Y1-Y2), and a pair of side wall portions 6432. The side wall portions 6432 are disposed one at each of the opposite end parts of the holding main body 6431 in the axial direction (Y1-Y2). The side wall portions 6432 have insertion holes 6432a penetrating them in the axial direction (Y1-Y2), and in the insertion holes 6432a, the shaft 642 is inserted. The shaft 642 is fixed to the pair of side wall portions 6432 to be stationary (so as not to rotate about the rotation axis J2).

The holding member 643 further includes a pair of first support portions 6433. The first support portions 6433 respectively protrude from the outer surfaces of the side wall portions 6432 in the axial direction (Y1-Y2). The first support portions 6433 are respectively inserted in a support hole (unillustrated) formed in the housing 69. With this arrangement, the holding member 643 is supported in the housing 69 via the first support portions 6433 so as to be swingable about a swing axis J1.

The holding member 643 further includes pressed pieces 6434 and 6435. The pressed pieces 6434 and 6435 each protrude from the holding main body 6431 in a radial direction. The pressed piece 6434 is biased by a pressure mechanism (unillustrated) in a direction of approaching the feed roller 63. The pressed piece 6435 is biased by a separation mechanism (unillustrated) in a direction of separating from the feed roller 63.

The torque limiter 644 switches the roller main body 641 between rotation and stopping.

The torque limiter 644 includes an inner cylindrical portion 644a, an outer cylindrical portion 644b, and a spring (an elastic member) 644c (see FIG. 5). The inner cylindrical portion 644a and the outer cylindrical portion 644b are coaxially disposed. The outer cylindrical portion 644b is disposed on the one side Y1 of the roller main body 641 in the axial direction, and is fixed to the shaft 642 to be stationary (so as not to rotate about the rotation axis J2).

The inner cylindrical portion 644a is a tubular body inserted so as to be rotatable with respect to the shaft 642. An end part of the inner cylindrical portion 644a on the other side Y2 in the axial direction is internally fit into the outer cylindrical portion 644b via the spring 644c. On the other hand, to an end part of the inner cylindrical portion 644a on the one side Y1 in the axial direction, the roller main body 641 is externally fitted. The inner cylindrical portion 644a and the roller main body 641 are fixed to each other.

The spring 644c is a coil spring that allows torque to be transmitted or disconnected between the inner cylindrical portion 644a and the outer cylindrical portion 644b.

In a case where a single sheet P has entered the nip portion between the feed roller 63 and the retard roller 64, friction with the sheet P causes corresponding torque to be applied to the roller main body 641. At this time, the spring 644c is released, and the inner cylindrical portion 644a and the roller main body 641 rotate about the rotation axis J2. With this arrangement, the roller main body 641 is driven to rotate following the feed roller 63, so that the sheet P having entered the nip portion can be sent out to a downstream side X1 in the conveyance direction.

On the other hand, in a case where a plurality of sheets P have entered the nip portion, no torque acts on the retard roller 64. At this time, the spring 644c is not released, so that the inner cylindrical portion 644a and the roller main body 641 do not rotate about the rotation axis J2. Accordingly, only one of the sheets P that is in contact with the feed roller 63 can be sent out to the downstream side X1 in the conveyance direction.

Further, in the present embodiment, the outer cylindrical portion 644b functions also as a restriction member that restricts the movement of the roller main body 641 in the axial direction Y2. The outer cylindrical portion 644b includes a locking portion 6442 and a second support portion 6441.

The locking portion 6442 has a snap-fitting structure, and includes a base portion 6442a and a claw portion 6442b. The base portion 6442a protrudes in the axial direction Y2 from an edge part of the outer cylindrical portion 644b on the other side Y2 in the axial direction. The claw portion 6442b protrudes from the base portion 6442a in a radial direction, and engages with the groove portion 642a of the shaft 642. With this arrangement, the outer cylindrical portion 644b is stably secured with respect to the shaft 642. Accordingly, it is possible to prevent the roller main body 641 and the inner cylindrical portion 644a from deviating toward the other side Y2 in the axial direction. In other words, the outer cylindrical portion (the restriction member) 644b is disposed on the other side Y2 of the roller main body 641 in the axial direction, and restricts the movement of the roller main body 641 in the axial direction Y2.

Further, the locking portion 6442 is capable of disengaging the claw portion 6442b from the groove portion 642a. With this arrangement, it is possible to release the locking to easily detach the outer cylindrical portion 644b from the shaft 642. Further, by detaching the outer cylindrical portion 644b from the shaft 642, the roller main body 641 and the inner cylindrical portion 644a can also be easily detached from the shaft 642. Accordingly, it is possible to enhance the workability in replacing the roller main body 641.

The second support portion 6441, which extends outward from the outer cylindrical portion 644b in a radial direction, includes a supporting protrusion portion 6441a disposed at a tip end thereof. The supporting protrusion portion 6441a is disposed on the same axis as the swing axis J1, and protrudes in the axial direction of the swing axis J1. The supporting protrusion portion 6441a is inserted in a support hole (unillustrated) formed in the housing 69. With this arrangement, the roller main body 641 is supported via the first support portions 6433 disposed on the opposite sides in the axial direction and the second support portion 6441, so as to be swingable about the swing axis J1. Further, with the holding member 643 pressed, the roller main body 641 is pressed against the feed roller 63.

By supporting the roller main body 641 from both of the opposite sides in the axial direction, it is possible to uniformize the pressing force, which is exerted by the roller main body 641 on the feed roller 63, all over the axial direction (Y1-Y2). As a result, it becomes possible to suppress uneven wear of the roller main body 641 toward one side in the axial direction (Y1-Y2) through continued use. Accordingly, it becomes possible to reduce occurrence of sheet conveyance failure. Furthermore, the roller main body 641 can operate maintenance-free for a longer period of time, which contributes to lower maintenance costs.

Moreover, since the first support portions 6433 are respectively disposed at two positions in the holding member 643, the roller main body 641 is allowed to swing in a stable manner when the holding member 643 is pressed.

In addition, since the restriction member is constituted by part (the outer cylindrical portion 644b) of the torque limiter 644, it is possible to suppress increase in the number of components of the retard roller 64.

It should be understood that the present disclosure is not limited to the above embodiment, and various modifications are possible within the scope of the present disclosure. For example, in the present embodiment, the restriction member is constituted by the outer cylindrical portion 644b of the torque limiter 644; however, the restriction member may alternatively be a member separate from a member (the outer cylindrical portion 644b) constituting the torque limiter 644. In that case, the outer cylindrical portion 644b, serving as the restriction member, is disposed independently of the spring 644c and the inner cylindrical portion 644a, and is disposed solely on the other side Y2 of the roller main body 641 in the axial direction. Further, the members (the inner cylindrical portion 644a, the outer cylindrical portion 644b, and the spring (the elastic member) 644c) constituting the torque limiter 644 are disposed inside the roller main body 641. With this arrangement, the retard roller 64 can be made compact in the axial direction (Y1-Y2) while achieving the above discussed effects.

What is claimed is:

1. A sheet feed device, comprising:
a feed roller that rotates when a driving force is transmitted thereto, thereby conveying a sheet; and
a retard roller that is pressed against the feed roller to form a nip portion and that conveys the sheet while separating the sheet from another sheet,
wherein
the retard roller includes:
a roller main body that rotates about a rotation axis;
a shaft that is attached to the roller main body and extends along the rotation axis;
a torque limiter that switches the roller main body between rotation and stopping;
a holding member that is disposed on one side of the roller main body in an axial direction thereof and that supports the shaft; and
a restriction member that is disposed on another side of the roller main body in the axial direction thereof, that includes a locking portion locked to the shaft, and that restricts movement of the roller main body in the axial direction thereof, and
the roller main body is swingably supported via a first support portion provided in the holding member and a second support portion provided in the restriction member, and the roller main body is pressed against the feed roller.

2. The sheet feed device according to claim 1,
wherein
the first support portion is disposed at each of two positions in the support member.

3. The sheet feed device according to claim 1,
wherein
the restriction member is constituted by part of the torque limiter.

4. The sheet feed device according to claim 1,
wherein
the restriction member is a member separate from a member constituting the torque limiter, and
the member constituting the torque limiter is disposed inside the roller main body.

5. An image forming apparatus comprising the sheet feed device according to claim 1, wherein
the image forming apparatus prints an image on the sheet fed from the sheet feed device.
